(19) United States
(12) Patent Application Publication
(10) Pub. No.: US 2020/0156372 A1
(43) Pub. Date: May 21, 2020

(54) INK JET HEAD

(71) Applicant: SEIKO EPSON CORPORATION, Tokyo (JP)

(72) Inventors: Yu OKAMURA, MATSUMOTO-SHI (JP); Hiroyuki HAGIWARA, MATSUMOTO-SHI (JP); Katsuhiro OKUBO, AZUMINO-SHI (JP); Masahiko SATO, MATSUMOTO-SHI (JP)

(21) Appl. No.: 16/686,586

(22) Filed: Nov. 18, 2019

(30) Foreign Application Priority Data
Nov. 21, 2018 (JP) 2018-218000

(51) Int. Cl. B41J 2/14

(52) U.S. Cl. CPC B41J 2/14201; B41J 2002/14491

(57) ABSTRACT

An ink jet head including a body portion including a pressure generating portion, and a nozzle that discharges ink, a relay substrate that relays between the body portion and a printer, a cable that sends an electric signal from the printer to the relay substrate, and a cover unit that covers a cable connector that electrically couples the relay substrate and the cables to each other. The cable is drawn out to a portion external to the ink jet head through an opening portion open on a gravitational direction side with respect to the cable connector.

The present application is based on, and claims priority from JP Application Serial Number 2018-218000, filed Nov. 21, 2018, the disclosure of which is hereby incorporated by reference herein in its entirety.

### BACKGROUND

### 1. Technical Field

The present disclosure relates to an ink jet head.

### 2. Related Art

An ink jet recording apparatus includes an ink jet head. The ink jet recording apparatus is a device that discharges a liquid, serving as various types of ink, from a nozzle of the ink jet head. Such an ink jet recording apparatus includes a liquid discharge portion and a drive substrate that drives the discharge portion. For example, JP-A-2014-4767 discloses a liquid discharging apparatus including a liquid discharge portion and a drive substrate that drives the discharge portion. In the drive substrate, a connector terminal for a cable that sends an electric signal is disposed in a direction opposite the gravitational direction, and an opening is covered by a cover that is configured to deform along the cable. When the ink jet head discharges the liquid as droplets, portions of the discharged droplets are separated and minute liquid particles float in the air. Such minute liquid particles are referred to as a mist.

The ink jet head described in JP-A-2014-4767 includes an opening portion in a direction opposite the gravitational direction, and the opening portion is covered by a deformable cover. Furthermore, a hole is provided in the cover, and a flat signal cable is inserted through the hole. Accordingly, the hole of the cover opens and closes due to the vibration generated during printing. Furthermore, liquid mist may enter into the hole through a minute gap formed at the end portion of the signal cable. As a result, the mist may enter into where an electric connection portion that connects the signal cable and the substrate to each other is disposed, and the ink jet head may become not operable due to short-circuiting of the electric connection portion. Accordingly, an ink jet head that suppresses the mist, which had floated during the discharge of the liquid, from entering the opening even when the mist floats downwards due to gravitational force and an ink jet head in which adhesion of the mist to the electric connection portion does not easily occur and in which short-circuiting of the electric connection portion can be reduced has been awaited.

### SUMMARY

An ink jet head according to the present application includes a body portion including a pressure generating portion that applies a pressure to a liquid, and a nozzle that discharges the liquid to which the pressure has been applied, a relay substrate that relays an electric signal sent to the body portion, a cable that sends an electric signal to the relay substrate from an ink jet recording apparatus, and a cover unit that covers an electric connection portion that electrically couples the relay substrate and the cable to each other. In the ink jet head, the cable is drawn out to a portion external to the ink jet head through a cable passing portion open on a gravitational direction side with respect to the electric connection portion.

In the ink jet head described above, desirably, the cable includes a portion that is located between the relay substrate and the cable passing portion and that is inclined at an angle that is within an area between the gravitational direction and a direction orthogonal to the gravitational direction.

In the ink jet head described above, desirably, the cable passing portion includes a packing.

In the ink jet head described above, desirably, the relay substrate includes a plurality of the electric connection portions that couples a plurality of the cables to the relay substrate, and a single head attaching/detaching connector inserted into and coupled to the body portion.

In the ink jet head described above, desirably, the cover unit includes a cover portion that protects the relay substrate, and a substrate fixing portion that fixes the relay substrate to the cover portion, in which, desirably, the cover portion that protects the relay substrate includes, in a direction opposite a direction in which the head attaching/detaching connector is inserted, a protrusion.

### BRIEF DESCRIPTION OF THE DRAWINGS

FIG. 1 is a schematic perspective view illustrating a configuration of a printer.

FIG. 2 is a schematic perspective view illustrating a configuration of a carriage.

FIG. 3 is a schematic perspective view illustrating a configuration of an ink jet head.

FIG. 4 is a schematic sectional side view illustrating a configuration of an ink jet head.

FIG. 5 is a sectional plan view of a cover unit.

FIG. 6 is a schematic sectional side view illustrating a state in which the mist has adhered to a cable.

FIG. 7 is a cross-sectional view before the cover unit and a body portion are detached from each other.

FIG. 8 is a cross-sectional view after the cover unit and the body portion have been detached from each other.

### DESCRIPTION OF EXEMPLARY EMBODIMENTS

### Exemplary Embodiment

Hereinafter, exemplary embodiments will be described with reference to the drawings. Note that in the exemplary embodiments described below, various limitations are described as specific examples suitable for the present disclosure; however, the scope of the present disclosure is not limited to the configurations described below unless there is a description particularly implying that the present disclosure is limited thereby. Furthermore, a description of an ink jet head mounted on a printer will be given hereinafter as an example.

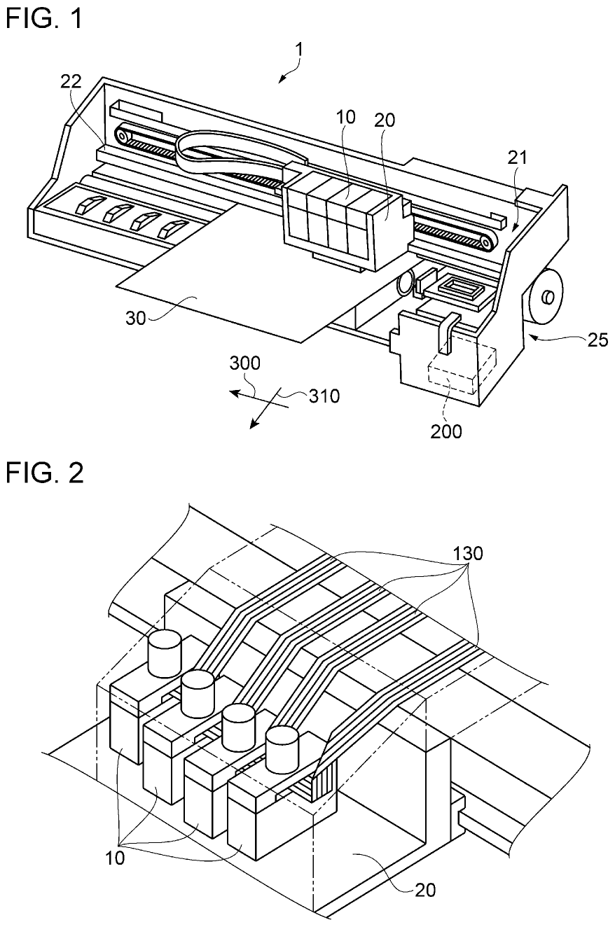

FIG. 1 is a schematic perspective view illustrating a configuration of the printer. As illustrated in FIG. 1, a printer 1 serving as an ink jet recording apparatus includes a carriage 20. The carriage 20 is configured to reciprocate along a guide rod 22 with a carriage moving mechanism 21. The carriage moving mechanism 21 that moves the carriage 20 includes a pulley and a timing belt. Ink serving as a liquid is sent to ink jet heads 10 through supply tubes (not shown). Furthermore, a recording medium 30 such as recording paper is sequentially transported in a sub scanning direction 310 with a recording medium sending device 25. Furthermore, the ink jet heads 10 are moved relative to the recording medium 30 in a width direction of the recording medium 30. The width direction of the recording medium is referred to as a main scanning direction 300. The main scanning direction 300 is a direction orthogonal to the sub scanning direction 310. Furthermore, based on electric signals from a control unit 200, ink is discharged from the ink jet heads 10 and the ink is applied onto the recording medium 30 to record an image and the like on the recording medium 30. Note that a configuration in which an ink cartridge is disposed in an ink jet head can be adopted as well.

FIG. 2 is a schematic perspective view illustrating a configuration of a carriage. As illustrated in FIG. 2, the plurality of the ink jet heads 10 are installed in the carriage 20 so that an ink application direction of each ink jet head 10 extends downwards in the drawing. Electric signals are sent to the ink jet heads 10 from the control unit 200 of the printer 1 through cables 130.

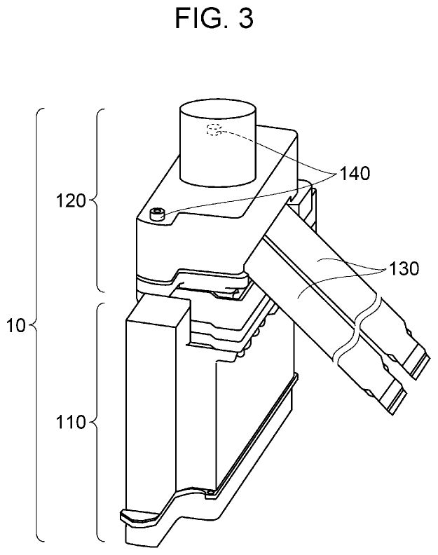

FIG. 3 is a schematic perspective view illustrating a configuration of the ink jet head. As illustrated in FIG. 3, the ink jet head 10 includes a body portion 110 and a cover unit 120. A connector is disposed on a surface of the ink jet head 10 on a side opposite the ink application direction. Furthermore, the cover unit 120 is coupled to the body portion 110 with the connector. Furthermore, the cover unit 120 is fixed to the body portion 110 with screws 140.

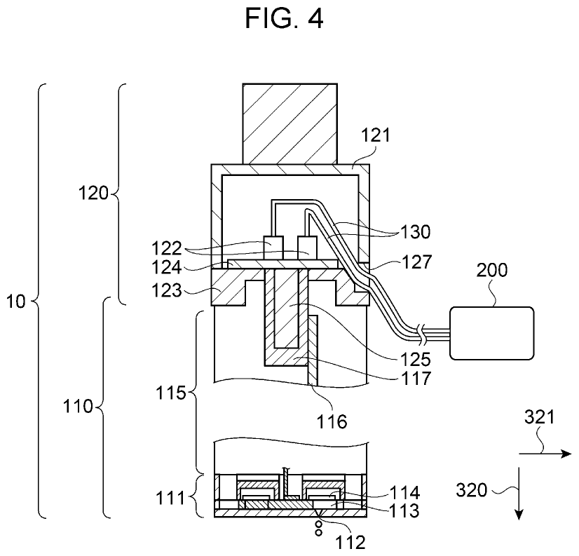

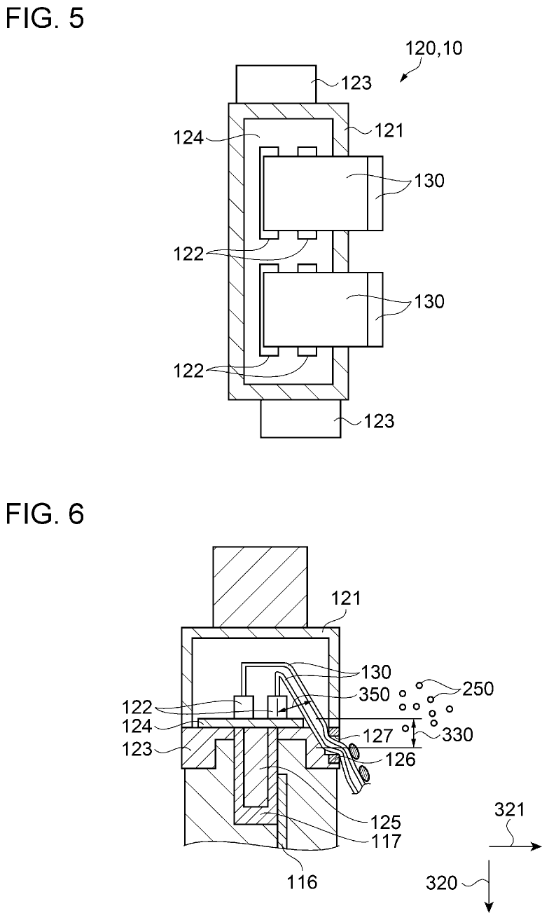

FIG. 4 is a sectional side view schematically illustrating a configuration of the ink jet head. FIG. 5 is a sectional plan view of the cover unit. As illustrated in FIG. 4, the body portion 110 includes a first structure 111 and a second structure 115. The first structure 111 includes a nozzle 112, a pressure generating portion 113, and a piezoelectric element 114. The second structure 115 is disposed on a side of the first structure 111 opposite the nozzle 112. The pressure generating portion 113 applies a pressure to the ink. Furthermore, the ink to which pressure has been applied is discharged from the nozzle 112. As described above, the body portion 110 includes the pressure generating portion 113 that applies a pressure to the ink, and the nozzle 112 that discharges the ink to which pressure has been applied.

The second structure 115 includes a body circuit board 116. A connector 117 is disposed on the body circuit board 116. An attaching/detaching connector 125 serving as a head attaching/detaching connector that is coupled to the body portion 110 by being inserted thereinto is disposed in a relay substrate 124 included in the cover unit 120. The connector 117 and the attaching/detaching connector 125 are electrically coupled to each other. Furthermore, the body circuit board 116 receives the electric signal from the control unit 200 of the printer 1 through the connector 117.

As illustrated in FIGS. 4 and 5, the cover unit 120 includes a cover portion 121 and a substrate fixing portion 123. The relay substrate 124 is installed so as to be interposed between the substrate fixing portion 123 and the cover portion 121. The cover portion 121 protects the relay substrate 124. Furthermore, the substrate fixing portion 123 fixes the relay substrate 124 to the cover portion 121.

Cable connectors 122 serving as four electric connection portions, and a single attaching/detaching connector 125 are mounted on the relay substrate 124. Cables 130 are coupled to the cable connectors 122. The cables 130 are electrically coupled to the control unit 200. The cables 130 send electric signals from the control unit 200 of the printer 1 to the relay substrate 124. Furthermore, the relay substrate 124 relays the electric signals sent to the body portion 110.

Terminals of the cable connectors 122 and terminals of the attaching/detaching connector 125 are electrically coupled to each other. The electric signals output from the control unit 200 are supplied to the body circuit board 116 through the cables 130, the cable connectors 122, and the attaching/detaching connector 125. The cover unit 120 includes an opening portion 127 serving as a cable passing portion open on a gravitational direction 320 side with respect to the cable connectors 122. The cables 130 are drawn out to an external portion through the opening portion 127.

The cables 130 pass through the opening portion 127. The cables 130 are drawn out to an external portion through the opening portion 127 open on the gravitational direction 320 side with respect to the cable connectors 122. Furthermore, the cables 130 include, between the relay substrate 124 and the opening portion 127, a portion that is inclined at an angle that is within an area formed between the gravitational direction 320 and a direction 321 orthogonal to the gravitational direction.

As described above, the body portion 110 of the ink jet head 10 includes the pressure generating portion 113 and the nozzle 112 that discharges the ink. Furthermore, the cables 130 send electric signals to the relay substrate 124. The relay substrate 124 relays the electric signals sent to the body portion 110.

The cover unit 120 covers the cables 130 and the cable connectors 122. The cable connectors 122 are portions electrically connected to the cables 130.

Accordingly, the ink jet head 10 includes the body portion 110, the relay substrate 124, the cables 130, and the cover unit 120. The ink jet head 10 receives the electric signals from the control unit 200 of the printer 1 through the four cables 130 and discharges droplets. When the droplets are discharged from the ink jet head 10, being separated from the droplets, minute liquids called a mist is created.

When, due to the air flow, the minute liquids float in the atmosphere, the minute liquids adhere to the electric connection portions of the relay substrate 124 disposed between the body portion 110 and the cables 130 and enter into where the electric connection portions are disposed, which leads to short-circuiting of the electric connection portions.

However, the electric connection portions of the ink jet head 10 are covered by the cover unit 120 and an opening direction of the cable passing portion is oriented towards the direction orthogonal to the gravitational direction. Accordingly, even when the floating mist during the discharge of the ink floats down by gravitational force, entering of the mist through the opening portion 127 can be suppressed.

Furthermore, as described above, the cables 130 are inclined between the relay substrate 124 and the cable passing portion in the range between the gravitational direction 320 and the direction 321 orthogonal to the gravitational direction. Accordingly, even when the mist adhere to the cables 130 and starts to flow along the cables, there are no electric connection portions in the direction in which the mist flows. Accordingly, adhesion of the mist to the cable connectors 122 can be suppressed and short-circuiting of the cable connectors 122 can be reduced.

The cable connectors 122 and the attaching/detaching connector 125 are disposed on the relay substrate 124. By having the relay substrate 124 in between, the portion electrically coupled to the body portion 110 is integrated to the attaching/detaching connector 125 alone. Accordingly, since the process of attaching and detaching the four cables 130 to and from the body portion 110 can be simplified, ease of maintenance can be improved.

Specifically, in each of the cables 130, flexible wiring is coupled to the connector. The flexible wiring is coupled to the connector 117 of the body circuit board 116 from the attaching/detaching connector 125 of the relay substrate 124 through the cable connector 122. Based on the electric signal supplied to the body circuit board 116, the piezoelectric element 114 generates driving force that discharges the ink from the nozzle 112.

FIG. 6 is a schematic sectional side view illustrating a state in which the mist has adhered to the cable. As illustrated in FIG. 6, the cables 130 include portions between the relay substrate 124 and the opening portion 127 that are inclined at an inclined angle 350. Furthermore, the cables 130 are disposed so as to extend downwards in the gravitational direction 320 by a height 330 from the relay substrate 124 to the opening portion 127 and to pass through the opening portion 127.

Note that packings 126 may be installed in the opening portion 127. Desirably, the packings 126 deform according to the shape of the cables 130. The packings 126 are installed at the cover portion 121 of the cover unit 120 and at the substrate fixing portion 123, and are installed so that the cables pass between the packings 126. The packings 126 reduce the gap between the opening portion 127 and the cables 130. Accordingly, mist 250 moving along the cables 130 can be suppressed from entering into where the cable connectors 122 are disposed.

Not limited to any particular material, the material of the packing 126 may be any elastic material. For example, in addition to natural rubber, synthetic rubber such as nitrile rubber, silicone rubber, acrylic rubber, styrene butadiene rubber, fluororubber, ethylene propylene rubber, chloroprene rubber, butyl rubber, and perfluoro rubber, ethylene tetrafluoride rubber, resin, and the like are used for the packing 126.

Accordingly, even when the mist 250 that has been separated from the droplets during the discharge of ink from the nozzle 112 and that is floating adheres onto the cables 130 and turns into droplets, since gravitational force acts on the droplets, the droplets do not move towards the cover unit 120 side. Accordingly, entering of the droplets to the cable connectors 122 side from the opening portion 127 can be reduced. Furthermore, even when the ink drips on the cover unit 120 when the ink jet head is replaced, the ink can be suppressed from entering into where the cable connectors 122 are disposed.

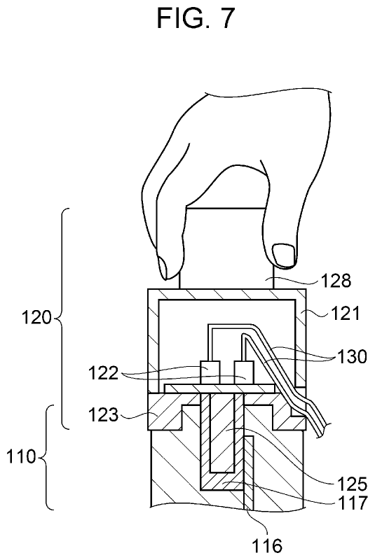

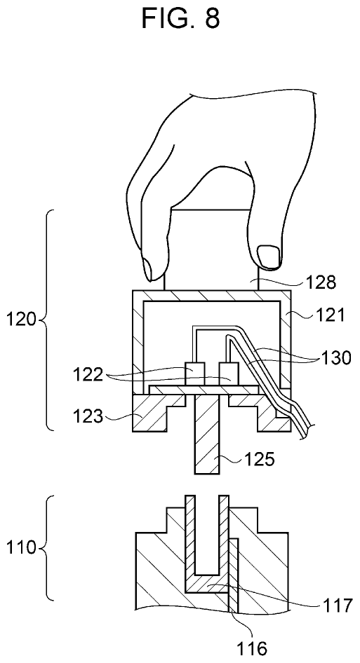

FIG. 7 is a cross-sectional view before the cover unit and the body portion are detached from each other, and FIG. 8 illustrates a cross-sectional view after the cover unit and the body portion have been detached from each other. As illustrated in FIGS. 7 and 8, the cover portion 121 of the cover unit 120 includes, in a direction opposite to the direction in which the attaching/detaching connector 125 is inserted, a protrusion 128. Note that the direction in which the attaching/detaching connector 125 is inserted is a direction in which the attaching/detaching connector 125 moves when the attaching/detaching connector 125 is inserted into the connector 117. By grabbing and pulling the protrusion 128, the operator can easily separate the body portion 110 and the cover unit 120 from each other. Since the protrusion 128 of the cover portion 121 becomes a handle, the ease of attaching/detaching is improved when, for example, there is a failure in the ink jet head.

### Other Exemplary Embodiments

While an exemplary embodiment of the present disclosure has been described above, the basic configuration of the present disclosure is not limited to that described above.

For example, while a schematic view in which four ink jet heads 10 are provided has been illustrated in the exemplary embodiment described above, the number of ink jet heads 10 is not limited in particular to the above number, and the printer 1 may include a single ink jet head 10 or the printer may include five or more ink jet heads.

Furthermore, for example, in the exemplary embodiment described above, while an example has been described in which four cable connectors 122 are mounted on the relay substrate 124, the number of cable connectors is not particularly limited to the above number. The number of cable connectors 122 mounted on the relay substrate 124 may be two, three, or five or more.

Furthermore, in the exemplary embodiment described above, an example has been described in which the nozzle 112 of the ink jet head 10 is provided on the lower side in the gravitational direction 320; however, not limited to the above configuration, for example, the nozzle 112 of the ink jet head 10 may be set in a state in which the direction in which the ink is discharged from the nozzle 112 is inclined 90° against the gravitational direction 320. In such a case, for example, the opening portion 127 is oriented towards the gravitational direction 320 side or oriented towards a direction inclined 90° against the gravitational direction 320, and the opening portion 127 is disposed on the gravitational direction 320 side with respect to the cable connectors 122.

Furthermore, while the printer 1 described above includes the protrusion 128 in the cover portion 121, when it is easy to grab the cover portion 121, the protrusion 128 does not have to be provided. A recess may be provided in place of the protrusion 128.

Furthermore, in the printer 1 described above, an example has been described in which the ink jet heads 10 mounted in the carriage 20 move in the main scanning direction; however, not limited to the above configuration, for example, a line recording apparatus in which the ink jet heads 10 are fixed to the printer and in which printing is performed by just moving the recording medium 30 such as paper in the sub scanning direction may be applied to the present disclosure.

Note that the ink jet head described above can be applied to, for example, various recording heads used in image recording apparatuses such as a printer, a coloring material ejecting head used in manufacturing a color filter of a liquid crystal display and the like, an electrode material ejecting head used to form electrodes of an organic EL display, a field emission display (FED), and the like, and a bio organic matter ejecting head used to manufacture biochips.

Hereinafter, contents that are derived from the exemplary embodiments will be described.

An ink jet head according to the present application includes a body portion including a pressure generating portion that applies a pressure to a liquid, and a nozzle that discharges the liquid to which the pressure has been applied, a relay substrate that relays an electric signal sent to the body portion, a cable that sends an electric signal to the relay substrate from an ink jet recording apparatus, and a cover unit that covers an electric connection portion that electrically couples the relay substrate and the cable to each other, in which the cable is drawn out to a portion external to the ink jet head through a cable passing portion open on a gravitational direction side with respect to the electric connection portion.

According to such a configuration, the ink jet head includes the body portion, the relay substrate, the cable, and the cover unit. Furthermore, the ink jet head receives electric signals from an ink jet recording apparatus through a plurality of cables and discharges droplets. When the droplets are discharged from the ink jet head, being separated from the droplets, minute liquids called a mist is created. When, due to the air flow, the minute liquids float in the atmosphere, the minute liquids adhere to the electric connection portions of the relay substrate disposed between the body portion and the cables and enter into where the electric connection portions are disposed, which leads to short-circuiting of the electric connection portions. In the ink jet head, the electric connection portions are covered by the cover unit, and the cable passing portion is disposed on the gravitational direction side with respect to the electric connection portions. Accordingly, even when the mist floating during the discharge of the ink floats down by gravitational force, entering of the mist through the cable passing portion can be suppressed and adhesion of the mist to the electric connection portions does not easily occur; accordingly, short-circuiting of the electric connection portions can be reduced.

In the ink jet head described above, the cable desirably includes a portion that is located between the relay substrate and the cable passing portion and that is inclined at an angle that is within an area between the gravitational direction and a direction orthogonal to the gravitational direction.

In such a configuration, the cables coupled to the relay substrate are, between the relay substrate and the cable passing portion, inclined within the area between the gravitational direction and the direction orthogonal to the gravitational direction. Even when the mist adhere to the cables and starts to flow along the cables, there are no electric connection portions in the direction in which the mist flows. Accordingly, the mist moving along the cables can be suppressed from adhering to the electric connection portions and short-circuiting of the electric connection portions can be reduced.

In the ink jet head described above, the cable passing portion desirably includes a packing.

According to such a configuration, the cable passing portion includes the packing. The packing reduces the gap between the cable passing portion and the cables. Accordingly, the mist moving along the cables and entering into where the electric connection portions are disposed can be suppressed.

In the ink jet head described above, the relay substrate includes a plurality of the electric connection portions that couples a plurality of the cables to the relay substrate, and a single head attaching/detaching connector inserted into and coupled to the body portion.

According to such a configuration, the ink jet head receives electric signals from an ink jet recording apparatus through the cables and discharges droplets. In the above, as a measure against an overshoot, a plurality of cables are distributed. When there is a failure in the ink jet head, the ink jet head is detached and is replaced with a normal ink jet head. When replacing the ink jet head, the ink jet head needs to be replaced by inserting and pulling out a plurality of cables.

However, the plurality of cable connectors and a single head attaching/detaching connector are disposed on the relay substrate. Accordingly, by having the relay substrate in between, the portion electrically coupled to the body portion is integrated to the head attaching/detaching connector alone. Accordingly, the operation and the process of attaching/detaching the plurality of cables to/from the body portion can be simplified and ease of maintenance can be improved.

In the ink jet head described above, desirably, the cover unit includes a cover portion that protects the relay substrate, and a substrate fixing portion that fixes the relay substrate to the cover portion, in which, desirably, the cover portion that protects the relay substrate includes, in a direction opposite a direction in which the head attaching/detaching connector is inserted, a protrusion.

According to such a configuration, in the cover unit, the relay substrate is fixed to the substrate fixing portion, and the substrate fixing portion is fixed to the cover portion. When there is a failure in the ink jet head, the ink jet head is detached and is replaced with a normal ink jet head. When replacing the ink jet head, the ink jet head needs to be lifted while being replaced. The protrusion is disposed in the cover portion in the direction opposite the direction in which the head attaching/detaching connector is inserted. Accordingly, since the protrusion becomes a handle when replacing the ink jet head, ease of attaching/detaching can be improved.

What is claimed is:

1. An ink jet head comprising:
a body portion including a pressure generating portion that applies a pressure to a liquid, and a nozzle that discharges the liquid to which the pressure has been applied;
a relay substrate that relays an electric signal sent to the body portion;
a cable that sends an electric signal to the relay substrate from an ink jet recording apparatus; and
a cover unit that covers an electric connection portion that electrically couples the relay substrate and the cable to each other, wherein
the cable is drawn out to a portion external to the ink jet head through a cable passing portion open on a gravitational direction side with respect to the electric connection portion.

2. The ink jet head according to claim 1, wherein
the cable includes a portion that is located between the relay substrate and the cable passing portion and that is inclined at an angle that is within an area between the gravitational direction and a direction orthogonal to the gravitational direction.

3. The ink jet head according to claim 1, wherein
the cable passing portion includes a packing.

4. The ink jet head according to claim 1, wherein
the relay substrate includes,
a plurality of the electric connection portions that couples a plurality of the cables to the relay substrate, and
a head attaching/detaching connector inserted into and coupled to the body portion.

5. The ink jet head according to claim 4, wherein
the cover unit includes,
a cover portion that protects the relay substrate, and
a substrate fixing portion that fixes the relay substrate to the cover portion, wherein
the cover portion that protects the relay substrate includes, in a direction opposite a direction in which the head attaching/detaching connector is inserted, a protrusion.
